(19) United States
(12) Patent Application Publication
(10) Pub. No.: US 2007/0219883 A1
(43) Pub. Date: Sep. 20, 2007

(54) Mortality And Longevity Indexed Financial Instruments

(76) Inventors: Ethan Bronsnick, New York, NY (US); Wendell Dave Dowrich, Norwalk, CT (US)

Correspondence Address: BAKER BOTTS L.L.P., 30 ROCKEFELLER PLAZA, 44TH FLOOR, NEW YORK, NY, 10112-4498, US

(21) Appl. No.: 11/618,265

(22) Filed: Dec. 29, 2006

Related U.S. Application Data
(63) Continuation of application No. 11/195,233, filed on Aug. 2, 2005.
(60) Provisional application No. 60/755,270, filed on Dec. 30, 2005.

(51) Int. Cl. G06Q 40/00

(52) U.S. Cl. 705/35

(57) ABSTRACT

Financial instruments are indexed to a standardized measure of publicly available longevity and mortality demographic data. A first financial instrument includes a zero-coupon bond and Experience Coupons. The zero-coupon bond accrues interest over its term at a base interest rate. The Experience Coupons, which are responsive to differences in actual and projected longevity/mortality data, either supplement or erode the value of the zero-coupon bond according to the direction of the differences in actual and projected longevity/mortality data. A second financial instrument is a swap in which counterparties trade expectations that actual mortality or longevity experience will be better or worse than projected mortality or longevity experience for a selected population cohort.

### CROSS-REFERENCE TO RELATED APPLICATION

This application is related to and claims priority from U.S. Provisional Application No. 60/755,270 entitled “Longevity And Mortality Indexed Notices,” filed on Dec. 30, 2005 and U.S. patent application Ser. No. 11/195,233 entitled “System and Method for Providing Mortality Rate Information and Employing It for Structuring and Analysis of Financial Instruments,” filed on Aug. 2, 2005, which applications are hereby incorporated by reference herein in their entirety.

### FIELD OF THE INVENTION

The present invention relates to the field of finance and capital markets. In particular, the invention relates to financial instruments and securities for risk managed investing by individuals, insurance companies and other institutions.

### BACKGROUND OF THE INVENTION

Index-based securities and financial instruments are common. For example, some securities are based on common market indices such as the NASDAQ-100 Index (symbol QQQ) and can be bought and sold like stock. Similarly, some debt instruments such as Treasury Inflation-Protected Securities (TIPS) have their principal and interest indexed to the official Consumer Price Index (CPI). These indexed securities and financial instruments, provide investors with choices for diversity, simplicity, flexibility, liquidity, ease of trading, risk management, and in some cases tax efficiency, in investing or portfolio management.

The available index-based securities and financial instruments, however, are generally based on indices of financial market behavior. Such indices do not provide suitable measures for structuring and settling financial transactions involving mortality and longevity risks that are of concern, for example, to insurance and reinsurance companies, providers of post-retirement benefits, and other mortality and longevity investors and risk takers.

Consideration is now being given to structuring and settling financial transactions involving mortality and longevity risks. Attention is particularly directed to developing financial instruments that are indexed to mortality and longevity data in a transparent and objective manner.

### SUMMARY OF THE INVENTION

Financial instruments and securities (“financial instruments”) that are indexed to mortality and longevity data are provided. Exemplary financial instruments indexed to mortality and longevity data include, without limitation, debt instruments, bonds, notes, swaps, derivatives, hybrid securities and other types. The financial instruments may be indexed to a suitable standardized measure (or index) of publicly available mortality and longevity data for a select population. An exemplary index on which the financial instruments may be based is the Credit Suisse Longevity Index^{SM} (CSLI), which is released annually. The index values are based on statistical demographic data, which represent and/or are derived from mortality experience over a defined measurement period (e.g., two or three years, or any such other measurement period as may be desirable) prior to the index release year.

An exemplary financial instrument is an indexed note (e.g. a longevity or a mortality indexed note) that is structured as a zero-coupon bond, which accrues periodic interest over its lifetime. A premium is associated with the bond when the longevity or mortality experience of a select population as measured by the index is positive. The premium, which may be paid out in current cash, further enhances the return on the bond. Similarly, a discount is applied to the bond when the longevity or mortality experience as measured by the index is negative. The discount may erode current and prior interest accruals on the bond, or, if necessary, the bond principal itself.

Other exemplary financial instruments, which may be based on mortality and longevity indices such the CSLI, are swaps (such as longevity or mortality swaps). A longevity or mortality swap may involve swapping fixed and floating interest rates (e.g., a fixed LIBOR for a floating LIBOR). In a preferred embodiment of the invention, the longevity or mortality swap involves swapping fixed and floating (or variable) payment amounts that are respectively based on the projected and actual longevity or mortality experiences. The preferred mortality swap may, for example, involve swapping a fixed “mortality” payment amount for a floating “mortality” payment amount, where the latter is equal to a notional amount (e.g., $N) times the actual mortality experience (e.g., =N*(M_{projected}−M_{actual})). Other types of swaps based on mortality and longevity indices may include asset swaps. In any case, the swaps, like the exemplary indexed notes, are structured to settle on the basis of the longevity or mortality experience as measured by the agreed-upon index. A contracted notional amount may be used to determine cash flows for periodic or final settlement at the end of the swap term (e.g., a year or any such other term as may be suitable or desirable) based on the longevity or mortality experience against initial longevity or mortality expectations.

Further features and advantages of the invention, as well as the structure and operation of various embodiments of the invention, are described in detail below with reference to the accompanying drawings.

### BRIEF DESCRIPTION OF THE DRAWING

The features, nature, objects, and various advantages of the present invention will become more apparent from the following detailed description and the accompanying drawings, wherein like reference characters represent like elements throughout, and in which:

FIGS. 1A and 1B are illustrative plots of projected (expected) and actual longevity/mortality data for a select population. The financial instruments of the present invention may be structured so that their values are responsive to the differences between the expected and actual longevity/mortality data or other standardized measures of longevity/mortality in a select population.

### DETAILED DESCRIPTION OF THE INVENTION

The present invention provides financial instruments that are indexed to standardized measures of mortality or longevity data of select populations. The selected populations may be national, regional, gender-specific populations or other population groups identified by other demographic criteria. The inventive financial instruments may be advantageously used as trading vehicles by financial investors and portfolio managers to trade or speculate on the mortality and longevity risks of the select populations.

Suitable indices have been developed for quantifying mortality or longevity data of select populations. For example, U.S. patent application Ser. No. 11/195,233, incorporated by reference herein, describes a standardized measure of the projected (expected) average lifetime for general populations based on publicly available demographic data and statistics. (See also Appendix A). The standardized measure disclosed therein, includes both historical and projected (expected) values of mortality or longevity in the United States and may be published annually by the assignee as the Credit Suisse Longevity Index^{SM} (“CSLI” index). This index or other similar standardized measures of longevity/mortality data (e.g., Survival Probabilities, Mortality Rates, or longevity/ mortality index values) may be used for structuring the inventive financial instruments.

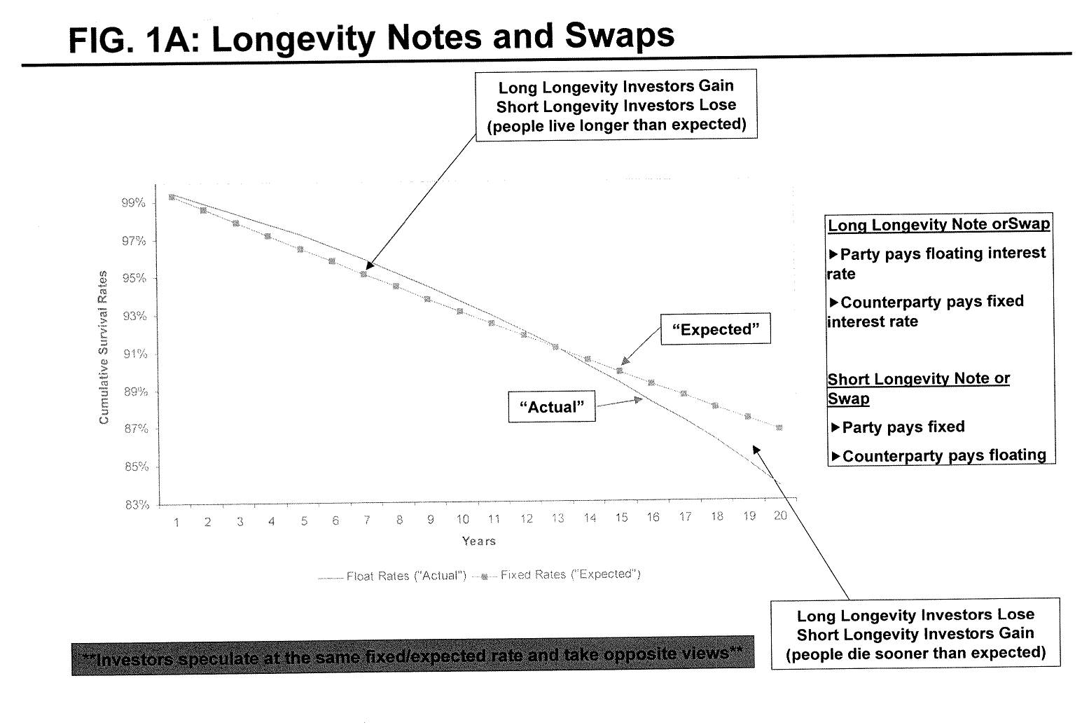

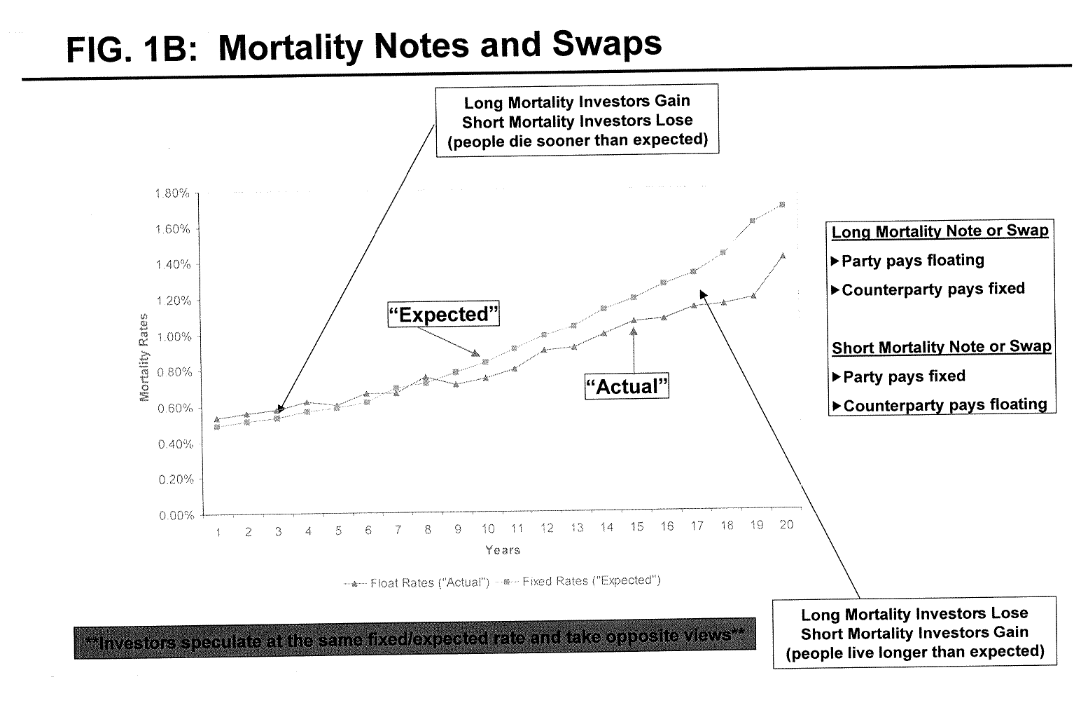

The longevity/mortality risk trading or balancing features of the inventive financial instruments can be understood with reference to FIGS. 1A and 1B, which are exemplary plots of projected and actual cumulative survival probabilities, and projected (expected) and actual mortality rates, respectively, of a select population. The select population underlying the financial instruments may be, for example, the group of current 50 year old males. The FIGS. show longevity and mortality data over an exemplary period of twenty years. In a preferred embodiment, the price of a longevity/mortality indexed financial instrument may be initially fixed or set according to survival probabilities, mortality rates, or longevity/mortality index values. However, the market price of a financial instrument (as determined, for example, in a suitable trading market) may vary as a function of the actual longevity/mortality experience (e.g., actual survival probabilities) of the select population as it ages over the term of the instrument. The market price of the financial instrument in any particular year may be higher or lower than the initially fixed or set value according to whether the actual survival probabilities are smaller or larger than expected survival probabilities. Thus, investors can speculate or trade on the longevity/mortality risk of the select population by buying, selling or holding the financial instrument according to their perception of the direction of the longevity/mortality trends in the select population.

A financial instrument according to the principals of the present invention may be structured so that its value is responsive to the difference between the actual and projected (expected) survival probabilities. In FIG. 1, the actual survival probabilities for the select population lie above the projected (expected) survival probabilities for about the first thirteen years of the twenty-year period shown. Similarly, the actual survival probabilities lie below the expected actual survival probabilities for about the last seven years of the twenty-year period shown. Accordingly, the value or market price of the financial instrument may be higher than the initially set value or price for about the first thirteen years, and lower than the initially set value or price for about the last seven years. An investor in the financial instrument who expects or risks that the actual survival probabilities will be lower than the expected survival probabilities is likely to be rewarded over the first thirteen years. Conversely, an investor in the financial instrument who anticipates or risks that the actual survival probabilities will be higher than the projected (expected) survival probabilities is likely to be rewarded over the last seven years shown in FIG. 1.

A longevity/mortality indexed financial instrument may be structured as a bond, a note, a swap, a derivative, a hybrid security or other type of instrument, according to the principles of the present invention. Particular examples of such a financial instrument include, without limitation, a Longevity Structured Note (“LSN”), a Mortality Structured Note (“MSN”), a Longevity Swap (“LS”), and a Mortality Swap (“MS”). It will be understood that these particular examples of financial instruments are selected only for convenience in illustration, and not as a limitation on the type of financial instruments included in the scope of the invention.

According to a preferred embodiment, the LSN is structured to reward investors who are long on longevity (i.e. who anticipate or risk that the select population will live longer than initially predicted). Conversely, the MSN is structured to reward investors who are short on longevity (i.e. who anticipate or risk that the select population will have a higher mortality rate than initially predicted).

According to a preferred embodiment, both the LSN and the MSN are structured notes that each include a zero coupon bond and at least one Experience Coupon. The zero-coupon bond may be like a conventional zero-coupon bond, which accrues interest over its term at a base rate and matures at its face value. Suitable bond terms may be 5, 10, 15 or 20 years for example or any such other terms as may be suitable or desirable. The “base” interest rate on the zero-coupon bond may be a fixed rate or an adjustable rate. The Conversely, an investor in the financial instrument who anticipates or risks that the actual survival probabilities will be higher than the projected (expected) survival probabilities is likely to be rewarded over the last seven years shown in FIG. 1.

A longevity/mortality indexed financial instrument may be structured as a bond, a note, a swap, a derivative, a hybrid security or other type of instrument, according to the principles of the present invention. Particular examples of such a financial instrument include, without limitation, a Longevity Structured Note (“LSN”), a Mortality Structured Note (“MSN”), a Longevity Swap (“LS”), and a Mortality Swap (“MS”). It will be understood that these particular examples of financial instruments are selected only for convenience in illustration, and not as a limitation on the type of financial instruments included in the scope of the invention.

According to a preferred embodiment, the LSN is structured to reward investors who are long on longevity (i.e. who anticipate or risk that the select population will live longer than initially predicted). Conversely, the MSN is structured to reward investors who are short on longevity (i.e. who anticipate or risk that the select population will have a higher mortality rate than initially predicted).

According to a preferred embodiment, both the LSN and the MSN are structured notes that each include a zero coupon bond and at least one Experience Coupon. The zero-coupon bond may be like a conventional zero-coupon bond, which accrues interest over its term at a base rate and matures at its face value. Suitable bond terms may be 5, 10, 15 or 20 years for example or any such other terms as may be suitable or desirable. The “base” interest rate on the zero-coupon bond may be a fixed rate or an adjustable rate. The adjustable rate may be based, for example, on LIBOR, a T-Bill rate or any other suitable periodical index.

In addition to the conventional interest accrual on the zero-coupon bond component, the LSN includes an Experience Coupon that reflect positive or negative longevity experience relative to projected expectations. According to a preferred embodiment of the current invention, positive longevity experience may be added to the Bond Book Value, accrete with LIBOR and be paid at maturity. Conversely, adverse longevity experience may first erode (i) prior positive Experience Coupons, then (ii) accrued interest and lastly (iii) to the extent necessary, erode the Bond Purchase Price.

According to another preferred embodiment of the present invention, the LSN may be structured so that if actual Cumulative Survival Rates are equal to expected Cumulative Survival Rates (see e.g., FIG. 1), the bond will accrete only at LIBOR, i.e. the Experience Coupons have zero value. If the actual Cumulative Survival Rates are higher than expected Cumulative Survival Rates for a particular year, a positive value may be calculated or assigned to the Experience Coupon, which is added to the Bond Book Value. Thus, for that particular year, the LSN has an “Implied Total Coupon” which is higher than the base rate (i.e. equal to “LIBOR plus”). Conversely, if the actual Cumulative Survival Rates are lower than the expected Cumulative Survival Rates for a particular year, an adverse value is calculated or assigned to the Experience Coupon for that year. The adverse Experience Coupon value is subtracted from the Bond Book Value. Thus, for that particular year the LSN has an Implied Total Coupon which is below the base rate (i.e. equal to “LIBOR minus”).

The values calculated or assigned to the LSN Experience Coupons in either circumstance may be bounded or limited, for example, to be no more than a fixed percentage of an original Bond Purchase Price.

Table I is a term sheet which explains the structure and operation of an exemplary LSN that has been structured according to the principles of the present invention.

TABLE I
Longevity Structured Note (“LSN”) Terms

| | |
|---|---|
| Zero-Coupon Bond Terms: | |
| Term: | 5, 10, 15, or 20 years |
| Bond Issuer: | Credit Suisse, New York Branch |
| Counterparty: | [INSERT BUYER] |
| Day Count: | [30/360 days] |
| Interest period: | Annually |
| Issue Date: | [INSERT DATE] |
| Maturity Date: | Issue Date plus [5] [10] [15] or [20] years |
| Bond Purchase Price | $[XX] |
| [Issue Size]: | |
| Bond Book Value: | At any time, the Bond Book Value is equal to the |
| | Bond Book Value at the end of the previous year, |
| | plus any accrued interest to date, plus the amount of |
| | any positive Experience Coupon and reduced by |
| | the amount of any negative Experience Coupon. |
| Face Value: | The ultimate accumulation of (i) principal, (ii) |
| | accrued interest, and (iii) net of all Experience |
| | Coupons, all paid to the Counterparty at the |
| | Maturity Date up to the Maximum Face Value. For |
| | clarity, this amount may be eroded by unfavorable |
| | longevity experience over the life of the bond. |
| Maximum Face Value: | [x] TIMES Issue Size |
| LIBOR: | [1-year] LIBOR |
| Implied Total Coupon: | The sum of (i) implied interest coupon (LIBOR |
| | times Bond Book Value) and (ii) Experience |
| | Coupon. |
| Experience Coupon Terms: | |
| Notional: | $XXXX |
| Experience Coupon: | The Experience Coupon is equal to: [(i) MINUS |
| | (ii)] TIMES (iii), where: |
| | (i) the Actual Cumulative Survival Rate, |
| | (ii) the Expected Cumulative Survival Rate, |
| | (iii) the Notional. |
| | Such Experience Coupon could be positive or |
| | negative. |
| Experience Coupon Limit: | The Experience Coupon in any given year, if |
| | positive, will not exceed [x]% of the Bond |
| | Purchase Price and if negative, will not exceed |
| | [y]% of the Bond Purchase Price. |
| Experience Coupon Calculation: | Prior to the Initial Experience Coupon Calculation |
| | Date, the Experience Coupon shall equal zero. |
| | On and after the Initial Experience Coupon |
| | Calculation Date, if the Experience Coupon is |
| | positive (longevity being better than expected |
| | because life expectancy increased), such positive |
| | Experience Coupon, up to a maximum of the |
| | Experience Coupon Limit, will be added to the |
| | Bond Book Value at the Experience Coupon |
| | Calculation Date. |
| | On and after the Initial Experience Coupon |
| | Payment Date, if the Experience Coupon is |
| | negative (longevity is worse than expected because |
| | life expectancy decreased), the Bond Book Value |
| | will be reduced by the absolute value of the |
| | negative Experience Coupon, up to a maximum of |
| | the Experience Coupon Limit, on the Experience |
| | Coupon Calculation Date. |
| Experience Coupon Calculation | Annually |
| Frequency: | |
| Initial Experience Coupon | [1^{st} quarter], 2009. The Credit Suisse Longevity |
| Calculation Date: | Index ^{SM} mortality rates are available on a 24-month |
| | lag. For example, the 2003 mortality rates |
| | published by the CSLI will be available in or about |
| | in January 2006. Therefore, the first coupon |
| | payment that reflects longevity experience will |
| | occur in or about January 2009, which is when the |
| | 2006 longevity experience data will be released. |
| Experience Coupon Calculation | The business day before the anniversary of the |
| Date: | Issue Date until the Maturity Date. |
| | In the event that a release of the Settlement Data |
| | Source is unavailable at the Experience Coupon |
| | Calculation Date, the Experience Coupon will be |
| | determined [10] days after the release of the |
| | Settlement Data (the “Late Experience Coupon |
| | Calculation Date”). Such Experience Coupon will |
| | be added to the Bond Book Value on the Late |
| | Experience Coupon Calculation Date. |
| Covered Life: | A representative life from the US General |
| | Population, whose gender and age are determined |
| | at the Issue Date of the Mortality Structured Note |
| | that is used to determine the Experience Coupons. |
| | The Covered Life will age through to the maturity |
| | of the Note. |
| | For example, in a 10-year bond on a 60-year old |
| | Male, the Experience Coupons are determined each |
| | year based on his longevity experience until he is |
| | 69 in the 10^{th} and final year of the bond. |
| Settlement Data Source: | The Credit Suisse Longevity Index ^{SM}. |
| Expected Mortality Rate: | The Expected Mortality Rates are determined from |
| | the Projected Mortality Curve, as published by the |
| | CSLI on or prior to the Issue Date. |
| Expected Cumulative Survival | For the Covered Life, the Expected Cumulative |
| Rates: | Survival Rates derived from the Expected Mortality |
| | Rate. For example, for a Covered Life age 60 at the |
| | Issued Date, the Expected Cumulative Survival |
| | Rate at time n is equal to: |
| | ₙp₆₀ = (1 − q₆₀)ⁿ. |
| Actual Mortality Rates: | The mortality rates released annually by the CSLI, |
| | for the Covered Life. |
| Actual Cumulative Survival Rates: | Calculated annually based on the Actual Mortality |
| | Rates for the Covered Life. For example, for a |
| | Covered Life age 60 at the Issue Date, the Actual |
| | Cumulative Survival Rate at the end of Year 3 is |
| | equal to: |
| | ₃p₆₀^{[t+2]} = (1 − q₆₀^{[t]}) (1 − q₆₁^{[t+1]}) (1 − q₆₂^{[t+2]}), where [t] is |
| | the year in which the mortality rate was released |
| | under the CSLI. |
| Other Conditions and | |
| Definitions | |
| Credit Suisse Longevity Index ^{SM} | The Credit Suisse Longevity IndexSM is a measure |
| (CSLI): | of the expected average lifetime for general |
| | populations based on publicly available statistics. |
| | The Longevity IndexSM, which includes both |
| | historical and projected determinations, will be |
| | released annually. The Longevity IndexSM and its |
| | underlying mortality rates serve as a common |
| | reference point for structuring and settling |
| | transactions involving mortality and longevity |
| | risks. The Longevity IndexSM calculation agent is |
| | Milliman, a global actuarial firm. |

Like the LSN, the MSN preferably includes Experience Coupons. However, unlike the LSN Experience Coupons which reflect positive or negative longevity experience, the MSN Experience Coupons reflect positive or negative mortality experience relative to projected expectations. According to a preferred embodiment, positive mortality experience may be added to the Bond Book Value, accrete with LIBOR and be paid at maturity. Conversely, adverse mortality experience may first erode (i) prior positive Experience Coupons, then (ii) accrued interest and lastly (iii) to the extent necessary, erode the Bond Purchase Price.

According to another preferred embodiment, the MSN may be structured so that if actual Mortality Rates are equal to expected Mortality Rates, the bond will accrete only at LIBOR, i.e. the Experience Coupons have zero value. If the actual Mortality Rates are higher than expected Mortality Rates for a particular year, a positive Experience Coupon value may be calculated or assigned and added to the Bond Book Value. Thus, for that particular year, the MSN has an “Implied Total Coupon” which is higher than the base rate (i.e. equal to “LIBOR plus”). Conversely, if the actual Mortality Rates are lower than the expected Mortality Rates for the particular year, an adverse Experience Coupon value is calculated or assigned for that year. The adverse Experience Coupon value is deducted from the Bond Book Value. Thus, for that particular year the MSN has an Implied Total Coupon which is below the base rate (i.e. equal to “LIBOR minus”).

In either circumstance, the values calculated or assigned to the MSN Experience Coupons (like the LSN Experience Coupon values) may be bounded or limited, for example, to be no more than a fixed percentage of an original Bond Purchase Price.

Table II is a term sheet which explains the structure and operation of an exemplary MSN that has been structured according to the principles of the present invention.

TABLE II
Mortality Structured Note (“MSN”) Terms

| | |
|---|---|
| Zero-Coupon Bond Terms: | |
| Term: | 5, 10, 15, or 20 years |
| Bond Issuer: | Credit Suisse, New York Branch |
| Counterparty: | [INSERT BUYER] |
| Day Count: | [30/360 days] |
| Interest period: | Annually |
| Issue Date: | [INSERT DATE] |
| Maturity Date: | Issue Date plus [5] [10] [15] or [20] years |
| Bond Purchase Price | $[XX] |
| [Issue Size]: | |
| Bond Book Value: | At any time, the Bond Book Value is equal to the |
| | Bond Book Value at the end of the previous year, |
| | plus any accrued interest to date, plus the amount of |
| | any positive Experience Coupon and reduced by |
| | the amount of any negative Experience Coupon. |
| Face Value: | The ultimate accumulation of (i) principal, (ii) |
| | accrued interest, and (iii) net of all Experience |
| | Coupons, all paid to the Counterparty at the |
| | Maturity Date up to the Maximum Face Value. For |
| | clarity, this amount may be eroded by adverse |
| | mortality experience over the life of the bond. |
| Maximum Face Value: | [x] TIMES Issue Size |
| LIBOR: | [1-year] LIBOR |
| Implied Total Coupon: | The sum of (i) implied interest coupon (LIBOR |
| | times Bond Book Value) and (ii) Experience |
| | Coupon. |
| Experience Coupon Terms: | |
| Notional: | $XXXX |
| Experience Coupon: | The Experience Coupon is equal to: [(iv) MINUS |
| | (v)] TIMES (vi), where: |
| | (iv) the Actual Mortality Rate, |
| | (v) the Expected Mortality Rate, |
| | (vi) the Notional. |
| | Such Experience Coupon could be positive or |
| | negative. |
| Experience Coupon Limit: | The Experience Coupon in any given year, if |
| | positive, will not exceed [x]% of the Bond |
| | Purchase Price and if negative, will not exceed |
| | [y]% of the Bond Purchase Price. |
| Experience Coupon Calculation: | Prior to the Initial Experience Coupon Calculation |
| | Date, the Experience Coupon shall equal zero. |
| | On and after the Initial Experience Coupon |
| | Calculation Date, if the Experience Coupon is |
| | positive (mortality being better than expected |
| | because life expectancy increased), such Positive |
| | Experience Coupon, up to a maximum of the |
| | Experience Coupon Limit, will be added to the |
| | Bond Book Value at the Experience Coupon |
| | Calculation Date. |
| | On and after the Initial Experience Coupon |
| | Payment Date, if the Experience Coupon is |
| | negative (mortality is worse than expected because |
| | life expectancy decreased), the Bond Book Value |
| | will be reduced by the absolute value of the |
| | Negative Experience Coupon, up to a maximum of |
| | the Experience Coupon Limit, on the Experience |
| | Coupon Calculation Date. |
| Experience Coupon Calculation | Annually |
| Frequency: | |
| Initial Experience Coupon | [1^{st} quarter], 2009. The Credit Suisse Longevity |
| Calculation Date: | Index ^{SM} mortality rates are available on a 24-month |
| | lag. For example, the 2003 mortality rates |
| | published by the CSLI will be available in or about |
| | in January 2006. Therefore, the first coupon |
| | payment that reflects longevity experience will |
| | occur in or about January 2009, which is when the |
| | 2006 longevity experience data will be released. |
| Experience Coupon Calculation | The business day before the anniversary of the |
| Date: | Issue Date until the Maturity Date. |
| | In the event that a release of the Settlement Data |
| | Source is unavailable at the Experience Coupon |
| | Calculation Date, the Experience Coupon will be |
| | determined [10] days after the release of the |
| | Settlement Data (the “Late Experience Coupon |
| | Calculation Date”). Such Experience Coupon will |
| | be added to the Bond Book Value on the Late |
| | Experience Coupon Calculation Date. |
| Covered Life: | A representative life from the US General |
| | Population, whose gender and age are determined |
| | at the Issue Date of the Mortality Structured Note, |
| | which is used to determine the Experience |
| | Coupons. The Covered Life will age through to the |
| | maturity of the Note. |
| | For example, in a 10-year bond on a 60-year old |
| | Male, the Experience Coupons are determined each |
| | year based on his longevity experience until he is |
| | 69 in the 10^{th} and final year of the bond. |
| Settlement Data Source: | The Credit Suisse Longevity Index ^{SM}. |
| Expected Mortality Rate: | The Expected Mortality Rates are determined from |
| | the Projected Mortality Curve, as published by the |
| | CSLI on or prior to the Issue Date. |
| Actual Mortality Rates: | The mortality rates released annually by the CSLI, |
| | for the Covered Life. |
| Other Conditions and | |
| Definitions | |
| Credit Suisse Longevity Index ^{SM} | The Credit Suisse Longevity IndexSM is a measure |
| (CSLI): | of the expected average lifetime for general |
| | populations based on publicly available statistics. |
| | The Longevity IndexSM, which includes both |
| | historical and projected determinations, will be |
| | released annually. The Longevity IndexSM and its |
| | underlying mortality rates serve as a common |
| | reference point for structuring and settling |
| | transactions involving mortality and longevity |
| | risks. The Longevity IndexSM calculation agent is |
| | Milliman, a global actuarial firm. |

Like the LSN and MSN, the exemplary LS and MS swaps are financial instruments designed for trading the difference between the longevity or mortality expectations of the swapping counterparties.

In a LS, the counterparties in a swap trade exchange settlement payments, which may be derived by monitoring actual cumulative survival rates versus a set of projected (expected) cumulative survival rates set at the trade's inception. Conversely, in a MS the counterparties exchange settlement payments, which may be derived by monitoring actual mortality rates versus a set of projected (expected) mortality rates set at the trade's inception. The swap trades may monitor an exemplary “Covered Life”, represented by a given age of a select population, as that representative person ages over the life of the trade.

In the LS trade, the party/counterparty (or investor) trade the expectation that actual longevity experience will be better/worse than the strike longevity experience. The investor gains if mortality is lower than expected, or cumulative survival probabilities are higher than expected. In other words, the investor holds a long position in the longevity swap.

In a preferred embodiment, the exemplary LS trade has a term of 5 years or longer, and monitors one U.S. general population age through the term of the note (e.g., the cumulative survival rate for a 60 year old male is monitored each year as he ages). The notional amount used to determine the annual settlement of longevity experience may be preset. Expected annual cumulative survival rates may be set at the inception of the trade based on an agreed upon projected mortality curve for the selected age and gender. Both positive longevity experience (mortality being better than expected because life expectancy increased) and negative longevity experience (mortality is worse than expected because life expectancy decreased) may be paid on an annual basis.

Table III is a term sheet which explains the structure and operation of an exemplary LS that has been structured according to the principles of the present invention.

Longevity Swap (“LS”) terms

| General Terms: | | | | |
|---|---|---|---|---|
| Floating Rate Payer: | [Credit Suisse International] | | | |
| Fixed Rate Payer: | [INSERT BUYER] | | | |
| Notional: | $XX | | | |
| Trade Date: | [TBD] | | | |
| Effective Date: | Corresponds to the 2009 CSLI release of 2006 mortality | | | |
| | data (expected first quarter of 2009) | | | |
| Termination Date: | [Five] consecutive annual Calculation Dates after the | | | |
| | Trade Date, currently anticipated to be [Mar. 31, 2013], | | | |
| | subject to the “Significant Change” and “Non- | | | |
| | publication of Data” provisions below. | | | |
| Settlement Data Source: | Credit Suisse Longevity Index (CSLI) | | | |
| Swap Calculation Agent: | Credit Suisse International | | | |
| Covered Life Profile: | 65 year old Male from the United States | | | |
| Expected Mortality Rates: | The Expected Mortality Rates for the Covered Life, | | | |
| | agreed to by both the Floating Rate Payer and the Fixed | | | |
| | Rate Payer prior to the Trade Date. Such rates are shown | | | |
| | in the following schedule: | | | |
| | Year | Age | Mortality Rate | |
| | 1 | 65 | | |
| | 2 | 66 | | |
| | 3 | 67 | | |
| | 4 | 68 | | |
| | 5 | 69 | | |
| Expected Cumulative Survival | For the Covered Life, the Expected Cumulative Survival | | | |
| Rates: | Rates derived from the Expected Mortality Rate. For | | | |
| | example, for a Covered Life age 65 at the Issued Date, | | | |
| | the Expected Cumulative Survival Rate at time t + 2 is | | | |
| | equal to: | | | |
| | ₃p₆₅^{[t+2]} = (1 − q₆₅^{[t]}) (1 − q₆₆^{[t+1]}) (1 − q₆₇^{[t+2]}). | | | |
| | Given the Expected Mortality Rates defined above, this | | | |
| | corresponds to the following schedule of Expected | | | |
| | Cumulative Survival Rates: | | | |
| | Year | Age | Mortality Rate | Cumulative Survival Rate |
| | 1 | 65 | | |
| | 2 | 66 | | |
| | 3 | 67 | | |
| | 4 | 68 | | |
| | 5 | 69 | | |

| | |
|---|---|
| | (p = cumulative survival rate; q = mortality rate) |
| Actual Mortality Rates: | The mortality rates released annually by the CSLI, for |
| | the Covered Life. |
| Actual Cumulative Survival Rates: | Calculated annually based on the Actual Mortality Rates |
| | for the Covered Life. For example, for a Covered Life |
| | age 65 at the Issue Date, the Actual Cumulative Survival |
| | Rate at the end of Year 3 is equal to: |
| | ₃p₆₅^{[t+2]} = (1 − q₆₅^{[t]}) (1 − q₆₆^{[t+1]}) (1 − q₆₇^{[t+2]}), where [t] is the |
| | year in which the mortality rate was released under the |
| | CSLI. |
| Initial Calculation Date: | [1^{st} quarter], 2009. The Credit Suisse Longevity Index ^{SM} |
| | mortality rates are available on a 25-month lag. For |
| | example, the 2003 mortality rates published by the CSLI |
| | were available in January 2006. Therefore, the first |
| | coupon payment that reflects longevity experience will |
| | occur in or about January 2009, which is when the 2006 |
| | longevity experience data will be released. |
| Subsequent Calculation Dates: | The business day after the anniversary of the Initial |
| | Calculation Date until the Termination Date. |
| | In the event that a release of the Settlement Data Source |
| | is unavailable at the Calculation Date, the Settlement will |
| | be determined [10] days after the release of the |
| | Settlement Data (the “Late Calculation Date”). |
| Settlement Terms: | |
| Fixed Rate Payment: | The Expected Cumulative Survival Rate times the |
| | Notional |
| Floating Rate Payment: | The Actual Cumulative Survival Rate times the Notional |
| Settlement Payment: | On each Calculation Date, a net settlement will be |
| | exchanged equal to the net of the Fixed Rate Payment |
| | and the Floating Rate Payment. |
| | When Actual Cumulative Survival Rates are greater than |
| | Expected Cumulative Survival Rates, the Floating Rate |
| | Payer will pay a net amount to the Fixed Rate Payer up |
| | to a maximum of the Settlement Payment Limit; and |
| | When the Actual Cumulative Survival Rates are lower |
| | than the Expected Cumulative Survival Rates, the Fixed |
| | Rate Payer will pay a net amount to the Floating Rate |
| | Payer up to a maximum of the Settlement Payment |
| | Limit. |
| Settlement Payment Limit: | [1]% of the Notional. |
| Covered Life: | A representative life from the US General Population, |
| | whose gender and age are determined at the Trade Date. |
| | The Covered Life will age through to the maturity of the |
| | transaction. |
| Fixed Rate Payer Collateral Pledge: | The Fixed Rate Payer will be required to pledge |
| | collateral in accordance with the Credit Support Annex |
| | of the ISDA Master Agreement between the Fixed Rate |
| | Payer and Floating Rate Payer. |
| Calculation Frequency: | Annually |
| Settlement Currency: | USD |
| Cash Settlement: | Applicable |
| Cash Settlement Payment Dates: | Two (2) Currency Business Days after the relevant |
| | Calculation Date |
| Other Conditions and Definitions | |
| Credit Suisse Longevity Index ^{SM} | The Credit Suisse Longevity Index ^{SM} is a measure of the |
| (CSLI): | expected average lifetime for general populations based |
| | on publicly available statistics. The Longevity Index ^{SM}, |
| | which includes both historical and projected |
| | determinations, will be released annually. The Longevity |
| | Index ^{SM} and its underlying mortality rates serve as a |
| | common reference point for structuring and settling |
| | transactions involving mortality and longevity risks. The |
| | transaction outlined in this term sheet will settle based |
| | on the underlying mortality rates of the Index. |
| Index Calculation Agent: | The Index Calculation Agent for the Longevity Index ^{SM} |
| | will be Milliman, a global actuarial firm. Pursuant to a |
| | separate agreement, (“Actuarial Agency Agreement”), |
| | Milliman will serve as Index Calculation Agent in |
| | respect of the Transaction, whose determinations and |
| | calculations shall be binding in the absence of manifest |
| | error. |

In an MS trade, the party/counterparty (or investor) trade the expectation that actual mortality experience will be better/worse than the strike mortality experience.

For brevity, a term sheet for an exemplary MS is not listed herein. However, it will be understood that the structure or terms of the MS may be similar to those of the LS listed in Table III with the recognizable difference that in the former settlement is based on mortality experience instead of longevity experience as in the latter.

The exemplary structured note and swap instruments (e.g., LSN, MSN, LS and MS) described herein provide investors with alternate structural choices for trading or balancing longevity/mortality risk. The exemplary LSN and LS are structured to settle based on cumulative survival rates while the exemplary MSN and MS are structured to settle on mortality rates.

Table IV outlines the positions in the respective exemplary notes or swaps that would be needed to achieve particular outcomes desired by investors. For example, if the investors desire to gain on longevity experience they could either (i) go long on LSN or LS, or (ii) go short on MSN or MS. The investors may select the appropriate investment positions on consideration, for example, of which note or swap structures better suit their return profile goals or investment policies and practices.

TABLE IV

| | INVESTORS' DESIRED OUTCOME: | |
|---|---|---|
| | POSITION TO | POSITION TO |
| | TAKE FOR GAIN | TAKE FOR GAIN |
| INSTRUMENT | ON LONGEVITY | ON MORTALITY |
| LONGEVITY | LONG | SHORT |
| NOTES AND | Gain when actual CSRs | Gain when actual |
| SWAPS | are higher than expected | CSRs are lower than |
| Settle on cumulative | | expected |
| survival rates (CSRs) | | |
| MORTALITY | SHORT | LONG |
| NOTES AND | Gain when actual | Gain when actual |
| SWAPS | mortality rates are lower | mortality rates are |
| Settle on mortality | than expected | higher than expected |
| rates | | |

It will be understood that the foregoing is only illustrative of the principles of the invention and that various modifications can be made by those skilled in the art without departing from the scope and spirit of the invention, which is limited only by the claims that follow. For example, although the foregoing describes preferred structures for note and swap instruments, those skilled in the art will appreciate that the principles of the invention may be applied to other financial instruments without departing from the scope and spirit of the present invention.

1. A financial instrument indexed to longevity/mortality data for a select population, the financial instrument comprising:
a zero-coupon bond having a term and which periodically accrues interest at a base rate over the term; and
at least an experience coupon, the experience coupon having a value responsive to a standardized measure of longevity and/or mortality data for the select population.

2. The financial instrument of claim 1 wherein the value of the experience coupon accrues to the value of the zero-coupon bond.

3. The financial instrument of claim 2 wherein the value of the experience coupon is a negative number which erodes the value of the zero-coupon bond.

4. The financial instrument of claim 1 wherein the value of the experience coupon is a positive number.

5. The financial instrument of claim 4 wherein the value of the experience coupon is payable in current cash.

6. The financial instrument of claim 1 wherein the select population is one of a national population, a regional population, a gender-specific population, a demographic grouping, and any combination thereof.

7. The financial instrument of claim 1 wherein the standardized measure of longevity and/or mortality data for the select population is an index which is released periodically during the term of the bond.

8. A longevity structured note or bond, comprising:
a first component which is a zero-coupon bond; and
a second component which has positive value, a zero value and a negative value when the difference between actual and projected Cumulative Survival Rates in a select population is positive, zero and negative, respectively,
wherein values of the second component are calculated periodically and wherein the longevity structured note or bond has a Bond Book Value which is the sum of the accrued values of the first component and the second component.

9. A mortality structured note or bond, comprising:
a first component which is a zero-coupon bond; and
a second component which has positive value, a zero value and a negative value when the difference between actual and projected Mortality Rates in a select population is positive, zero and negative, respectively,
wherein values of the second component are calculated periodically and wherein the mortality structured note or bond has a Bond Book Value which is the sum of the accrued values of the first component and the second component.

10. A financial instrument indexed to longevity/mortality data of a covered life, the financial instrument comprising:
a trade between counterparties of longevity/mortality expectations over a term;
an exchange of trade settlement payments, which are derived by monitoring actual longevity/mortality data of a covered life versus longevity/mortality data at the trade's inception.

11. The financial instrument of claim 10, wherein the covered life is represented by a particular age cohort in a select population.

12. The financial instrument of claim 10, wherein the term is a number of years and wherein the exchange of trade settlement payments comprises periodic calculations of payment flows.

13. The financial instrument of claim 10, comprising a swap of floating and fixed payment amounts between the counterparties.

14. The financial instrument of claim 10, comprising a swap of floating interest rate payments and fixed rate interest payments between the counterparties.

15. The financial instrument of claim 14, wherein settlement of the swap is based on the longevity experience of the covered life.

16. The financial instrument of claim 15, wherein settlement of the swap is based on the mortality experience of the covered life.
